(19) United States
(12) Patent Application Publication
(10) Pub. No.: US 2025/0181435 A1
(43) Pub. Date: Jun. 5, 2025

(54) DETECTING ERRORS IN CHAT BOT OUTPUTS USING LANGUAGE MODEL NEURAL NETWORKS

(71) Applicant: Google LLC, Mountain View, CA (US)

(72) Inventors: Nithum Thain, Toronto (CA); Tyler Akira Chang, San Diego, CA (US); Katrin Ruth Sarah Tomanek, San Francisco, CA (US); Jessica Hélène Hoffmann, Paris (FR); Erin MacMurray van Liemt, Marina del Rey, CA (US); Lucas Gill Dixon, Paris (FR); Kathleen Susan Meier-Hellstern, Cranbury, NJ (US)

(21) Appl. No.: 18/965,988

(22) Filed: Dec. 2, 2024

Related U.S. Application Data
(60) Provisional application No. 63/605,446, filed on Dec. 1, 2023.

(51) Int. Cl. G06F 11/07; G06F 40/35

(52) U.S. Cl. CPC G06F 11/0751; G06F 40/35

(57) ABSTRACT

Methods, systems, and apparatus, including computer programs encoded on computer storage media, for detecting errors in chat bot outputs. For example, the errors can be hallucination errors, coverage errors, or both.

### CROSS-REFERENCE TO RELATED APPLICATION

This application claims priority to U.S. Provisional Application No. 63/605,446, filed on Dec. 1, 2023. The disclosure of the prior application is considered part of and is incorporated by reference in the disclosure of this application.

### BACKGROUND

This specification relates to processing text using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that detects errors in responses generated by chat bots.

The subject matter described in this specification can be implemented in particular embodiments so as to realize one or more of the following advantages.

Large Language Models (LLMs) have risen in popularity due to state-of-the-art performance on a wide range of tasks, and this performance makes it desirable to use LLMs to deploy LLM-driven chat bots, i.e., chat bots that use LLMs to generate responses to user queries. While these chat bots are highly flexible and generalizable, they can be prone to generating errors. For example, chat bots can struggle with factuality and bias when generating responses to certain queries, reducing their usefulness when deployed for interactions with users.

However, determining in advance whether a given chat bot is likely to make errors, e.g., coverage errors or hallucination errors, is difficult. In particular, large, labeled data sets that can be used to test the performance of chat bots on inputs that are similar to those that will be processed after training are difficult to obtain. Thus, determining whether a chat bot will make errors after deployment is difficult.

This specification addresses these issues by using a classifier neural network, e.g., one that makes use of a language model neural network, to accurately score test inputs to determine whether the test inputs contain a specified type of error.

In particular, after training, the classifier neural network only needs access to candidate responses to user queries and responses generated by the chat bot when asked to evaluate the user queries, without needing any ground truth outputs specifying whether the response generated by the chat bot had an error or whether any of the candidate responses are accurate.

This allows the described techniques to effectively evaluate whether a given chat bot makes errors, even in the absence of labeled data. Thus, the described techniques can allow a system to more effectively determine whether a chat bot is suitable for deployment or whether an already-deployed chat bot needs to be updated or removed.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an example error detection system.

FIG. 2 is a flow diagram of an example process for detecting errors in chat bot outputs.

FIG. 3 is a flow diagram of an example process for generating a test input.

FIG. 4 is a flow diagram of an example process for training a language model neural network through prompt tuning to perform error detection.

FIG. 5 shows examples of inputs to the language model neural network.

Like reference numbers and designations in the various drawings indicate like elements.

### DETAILED DESCRIPTION

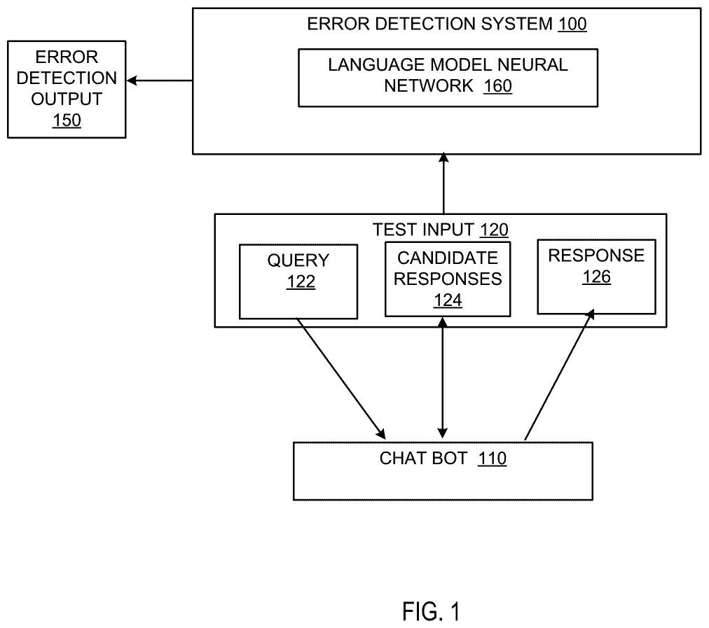

FIG. 1 shows an example error detection system 100. The error detection system 100 is an example of a system implemented as computer programs on one or more computers in one or more locations, in which the systems, components, and techniques described below can be implemented.

The system 100 detects errors in responses generated by chat bots 110.

Chat bots are computer software that generate natural language responses to user queries. For example, the chat bots can be large language model (LLM)-based chat bots that generate responses based on outputs generated by one or more LLMs. That is, a given chat bot 110 can receive a user query and generate a response to the user query by processing one or more inputs generated using the user query using one or more LLMs.

In particular, the system 100 detects errors using test inputs 120 that each include (i) a query 122, (ii) candidate responses 124 to the query, and (iii) a response 126 generated by the chat bot 110 to the query 122 that summarizes the candidate responses to the query.

For example, the chat bot 110 may have been presented with the query and the candidate responses 124 and given a prompt to summarize the candidate responses 124.

As a particular example, each candidate response 124 can be an argument or perspective on the query 122 from a different viewpoint. As a particular example, one candidate response 124 can be from a positive viewpoint on a topic referenced by the query 122, another candidate response 124 can be from a negative viewpoint on a topic referenced by the query 122, and so on. That is, the candidate responses 124 are each a response to the query 122, but contain different information due to having one or more properties from one or more of the other candidate responses 124, e.g., due to being generated from a different viewpoint, e.g., positive or negative, on the topic referenced by the query 122.

The system 100 can detect any of a variety of types of errors in the response 126 generated by the chat bot 110 within a given test input 120.

For example, the system 100 can detect “hallucination” errors. A hallucination error occurs when the response 126 generated by the chat bot 110 (incorrectly) references a candidate response 124 that is not included in the set of candidate responses 124 to the query 122. Thus, the response 124 generated by the chat bot 110 does not accurately summarize the set of candidate responses 124 because one or more “hallucinated” candidates are referenced in the summary that are not actually included in the set of candidate responses 124.

As another example, the system 100 can detect “coverage” errors. A coverage error occurs when the response 126 generated by the chat bot 110 does not reference one or more of the candidate responses 124 that are included in the set of candidate responses 124 to the query 122. Thus, the response 122 generated by the chat bot does not accurately summarize the set of candidate responses 124 because one or more of the candidate responses 124 are not “covered.” That is, the content of one or more of the responses in the candidate responses 124 is not described by the response 126 generated by the chat bot 110.

Thus, the system 100 receives a set of test inputs 120 and uses the test inputs 120 to generate, for each test input 120, an error detection output 150 that identifies whether the test input 120 are indicative of errors, e.g., coverage or hallucination errors, made by the chat bot 110.

As will be described in more detail below, the system 100 uses a language model neural network 160 to classify the test inputs 120 as being indicative of errors or not.

More specifically, the system 100 uses the language model neural network 160 to process inputs derived from a given test input 120 to generate a classification output for the test input 120 that characterizes whether the response generated by the chat bot has an error of a corresponding error type, e.g., a hallucination error or a coverage error or another appropriate error type.

The language model neural network 160 is a neural network that is configured to process an input to generate an output that includes a probability distribution over a set of text tokens in vocabulary of tokens, with the probability for each token representing the likelihood that the token immediately follows the input.

The vocabulary of tokens generally include text tokens and can optionally include tokens representing one or more other modalities, e.g., audio, image, video, and so on. The text tokens can include any appropriate tokens that appear in natural language text, e.g., ASCII characters, words, word pieces, or differently distributed n-grams. For example, the vocabulary of text tokens can be fixed or can have been generated by applying an appropriate tokenizer, e.g., a byte pair encoding tokenizer or the SentencePiece tokenizer to a corpus of text.

For example, the language model neural network 160 can be an auto-regressive language model neural network.

The language model neural network 160 is referred to as an auto-regressive neural network because the neural network auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence (a “context sequence”).

For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within a candidate output sequence, the neural network 160 can process the current input sequence to generate a score distribution, e.g., a probability distribution, that assigns a respective score, e.g., a respective probability, to each text token in the vocabulary of text tokens. The neural network 160 can then select, as the particular token, a text token from the vocabulary using the score distribution. For example, the neural network 160 can greedily select the highest-scoring token or can sample, e.g., using nucleus sampling or another sampling technique, a token from the distribution.

As a particular example, the language model neural network 160 can be an auto-regressive Transformer-based neural network that includes (i) a plurality of attention blocks that each apply a self-attention operation and (ii) an output subnetwork that processes an output of the last attention block to generate the score distribution.

The neural network 160 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

In some cases, the system 100 maintains multiple language model neural networks 160, with each language model neural network being configured to detect errors of a corresponding type, e.g., one neural network 160 for detecting hallucination errors and another neural network 160 for detecting coverage errors.

Using the language model neural network 160 to detect errors will be described in more detail below.

As a particular example, the system 100 can be used to evaluate a chat bot 110 before the chat bot 110 is deployed for use in responding to user queries.

For example, the system 100 can be used to determine whether the chat bot 110 makes errors when responding to test inputs 120, e.g., that are generated by another system and are representative of user queries that will be received by the chat bot 110. In response to determining that the chat bot software 110 has made an error in response to more than a threshold proportion of the test inputs 120, the system 100 can determine not to deploy the chat bot 110.

As another example, in response to determining that the chat bot software 110 has made an error in response to more than a threshold proportion of the test inputs 120, the system 100 can determine to further train or otherwise adapt the LLM(s) used by the chat bot 110 prior to deploying the chat bot 110.

As another particular example, the system 100 can be used to evaluate a chat bot 110 that has already been deployed to determine whether the chat bot 110 has ceased to function as intended, e.g., because the distribution of user queries has changed and has caused the chat bot 110 to generate an excessive number of errors.

For example, the system 100 can be used to determine whether the chat bot 110 makes errors when responding to test inputs 120 that are derived from recent query inputs received from users.

In response to determining that the chat bot software 110 has made an error in response to more than a threshold proportion of the test inputs 120, the system 100 can determine that the chat bot 110 is not exhibiting satisfactory performance and, as a result, determine to no longer use the chat bot 110 to respond to user queries or determine to further train or otherwise adapt the LLM(s) used by the chat bot 110.

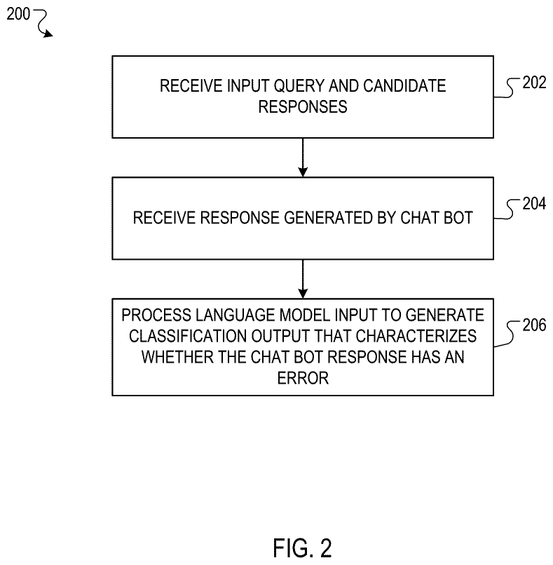

FIG. 2 is a flow diagram of an example process 200 for detecting errors of a particular type in chat bot outputs. For convenience, the process 200 will be described as being performed by a system of one or more computers located in one or more locations. For example, an error detection system, e.g., the error detection system 100 depicted in FIG. 1, appropriately programmed in accordance with this specification, can perform the process 200.

More specifically, the system can perform the process 200 on a given test input to detect whether the test input has an error of the particular type.

In some cases, the system detects only a single type of error, e.g., only a hallucination error or a coverage error.

In some other cases, the system can detect multiple different types of errors, e.g., both hallucination errors and coverage errors.

In these cases, the system can perform multiple instances of the process 200, one for each type of error and each using a respective language model neural network configured to detect the corresponding error type.

The system receives an input query and a plurality of candidate responses to the input query (step 202).

The system also receives a response generated by chat bot software for the input query that summarizes the candidate responses to the input query (step 204).

The system then processes a language model input that includes (i) the input query, (ii) the plurality of candidate responses, and (iii) the response generated by the chat bot software using a language model neural network to generate a classification output (step 206).

The classification output characterizes whether the response generated by the chat bot has an error of the particular error type, e.g., a hallucination error or a coverage error or another appropriate error type.

As described above, a hallucination error occurs when the response generated by the chat bot software references a candidate response that was not included in the plurality of candidate responses. A coverage error occurs when the response generated by the chat bot software does not reference one or more of the candidate responses that were included in the plurality of candidate responses.

For example, the classification output can be a confidence score that represents a likelihood that the response has an error of the given error type.

The language model neural network (LM) can be, e.g., a large language model neural network (LLM). For example, the LM can be a causally-masked, decoder-only Transformer neural network.

For example, when the classification output is a confidence score, the system can process the input using the language model neural network to generate a first score for a first natural language label, e.g., “yes” or “it does” that indicates that the response contains an error of the given error type and a second score for a second natural language label that indicates that the response does not contain an error of the given error type, e.g., “no” or “it does not.”

The system can then generate the confidence score from at least the first score and the second score. For example, the system can compute the confidence score as a probability by applying a softmax function to a set of scores that includes the first score and the second score. As a particular example, the system can use, as the confidence score, the probability generated from the first score by applying the softmax or the probability generated from the second score by applying the softmax.

The system can then classify the response as either containing an error of the first error type or not containing an error of the first error type based on the classification output.

For example, when higher scores indicate that the response is more likely to contain an error, the system can classify the response as containing an error when the score exceeds a threshold.

As another example, when lower scores indicate that the response is more likely to contain an error, the system can classify the response as containing an error when the score does not exceed the threshold.

In some implementations, the language model neural network is pre-trained by another system. For example, the language model neural network can have been pre-trained on a language modeling task and then fine-tuned on an instruction tuning task.

Optionally, to improve the performance of the language model neural network, the system can further train the language model neural network to detect errors of the corresponding type.

As one example, the system can perform prompt tuning on the language model neural network. In these examples, any given input sequence to the language model neural network will include a learned “soft” prompt that has been determined as a result of the prompt tuning. A soft prompt for a given task is a prompt that is included as part of each input for the given task and that includes one or more placeholder tokens that are each mapped to a respective embedding vector that (i) is the same dimensionality as the embeddings generated by the embedding layer of the language model neural network for the tokens in the vocabulary and (ii) has been learned during the prompt tuning of the language model neural network.

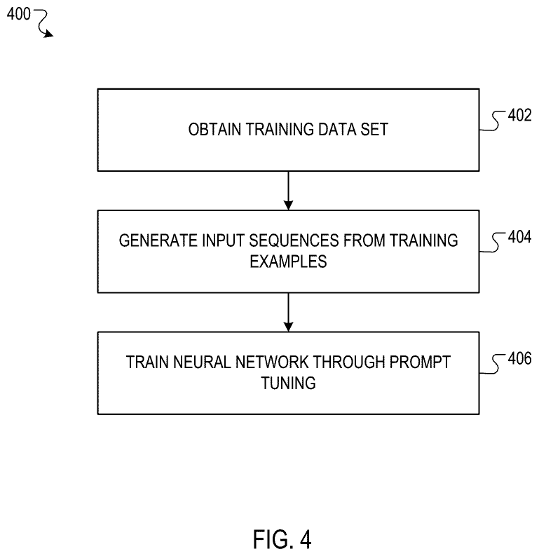

Performing prompt tuning is described in more detail below with reference to FIG. 4.

The input sequence can also include other information, e.g., an instruction, e.g., a natural language instruction to the language model neural network to analyze for errors of the particular type, e.g., “determine whether only the given arguments are contained in the neutral response” for hallucination error detection or “determine whether all of the given arguments are referenced in the neutral response” for coverage error detection.

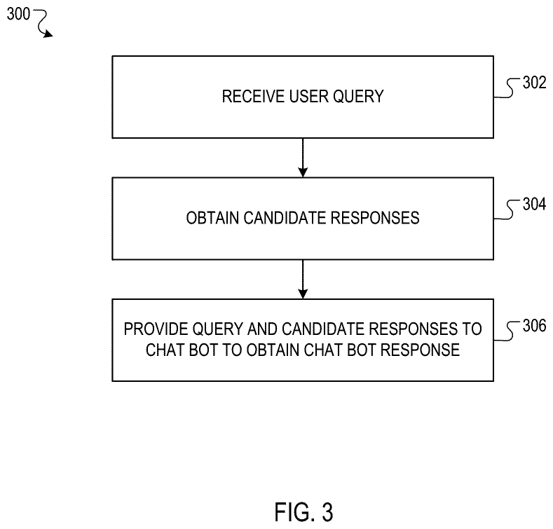

FIG. 3 is a flow diagram of an example process 300 for generating a test input to be provided as input to the language model neural network. For convenience, the process 300 will be described as being performed by a system of one or more computers located in one or more locations. For example, an error detection system, e.g., the error detection system 100 depicted in FIG. 1, appropriately programmed in accordance with this specification, can perform the process 300.

The system receives a user query (step 302).

The system obtains a set of candidate responses to the user query (step 304). As a particular example, each candidate response can be an argument or perspective on the query from a different viewpoint. As a particular example, one candidate response can be from a positive viewpoint on a topic referenced by the query, another candidate response can be from a negative viewpoint on a topic referenced by the query, and so on.

In some cases, the system can cause the language model neural network or the chat bot to generate the candidate responses. For example, for each possible viewpoint, the system can provide, as input to the chat bot or the language model neural network, the user query and an instruction to provide a response to the user query from the corresponding viewpoint.

In some other cases, the system can obtain the responses from another source, e.g., a data set available to the system.

The system provides the user query and the candidate responses to the chat bot and obtains, as output from the chat bot, a response that summarizes the candidate responses to the query (step 306).

For example, the system can provide the query, the candidate responses, and a prompt to summarize the candidate responses to the chat bot to cause the chat bot to generate the response that summarizes the responses.

FIG. 4 is a flow diagram of an example process 400 for training the language model neural network through prompt tuning. For convenience, the process 400 will be described as being performed by a system of one or more computers located in one or more locations. For example, an error detection system, e.g., the error detection system 100 depicted in FIG. 1, appropriately programmed in accordance with this specification, can perform the process 400.

In some cases, the system detects only a single type of error, e.g., only a hallucination error or a coverage error. In these cases, the system can perform a single instance of the process 400 to train a single instance of the language model neural network to detect errors of the corresponding type.

In some other cases, the system can detect multiple different types of errors, e.g., both hallucination errors and coverage errors.

In these cases, the system can perform multiple instances of the process 400, one for each type of error, to train a respective instance of the language model neural network to detect the corresponding error type.

The system obtains a training data set for performing prompt tuning (step 402).

The training data set includes a set of training examples.

Each training example includes: (i) a training query, (ii) a plurality of candidate responses to the training query, (iii) a training response to the training query, and (iv) a ground truth label indicating whether the training response contains an error of the corresponding type. Generally, the label is a natural language label, e.g., “yes” or “no” that indicates whether the training response contains an error of the corresponding type.

The system then trains the neural network on the training data set through prompt tuning. In particular, the system generates a respective input sequence from each training example (404). The input sequence for each training example includes the training query, the candidate responses, the training responses, and the ground truth label from the training example. The input sequence also includes a “soft” prompt, e.g., pre-pended to the remainder of the input sequence. As described above, the soft prompt includes a fixed number of embeddings (or, equivalently, a fixed number of placeholder tokens that are each mapped to a respective embedding) that are shared across all of the input sequences.

The system trains the neural network using the respective input sequences through prompt tuning to update the soft prompt while holding the parameters of the neural network fixed (step 406).

For example, the system can train the neural network on an objective that measures, for any given input sequence, the likelihood, e.g., the negative log likelihood, assigned to the ground truth label by the language model neural network by processing the input sequence.

Thus, during this training, the system updates the embeddings in the soft prompt while holding the parameter of the neural network fixed, including the parameters of the embedding layer that define the embeddings of the tokens in the vocabulary. For example, during this training, for each of multiple batches of training examples, the system can backpropagate gradients of the objective for the training examples in the batch through the neural network in order to determine a respective gradient with respect to each of the embeddings in the soft prompt. The system can then update each of the embeddings in the soft prompt by applying an optimizer to the respective gradient with respect to the embedding. The optimizer can be any appropriate machine learning optimizer, e.g., stochastic gradient descent, Adam, or Adafactor.

By repeatedly performing this updating, the system learns embeddings that cause the neural network to, when the embeddings are included in inputs to the neural network, accurately detect errors of the corresponding type in the inputs to the neural network.

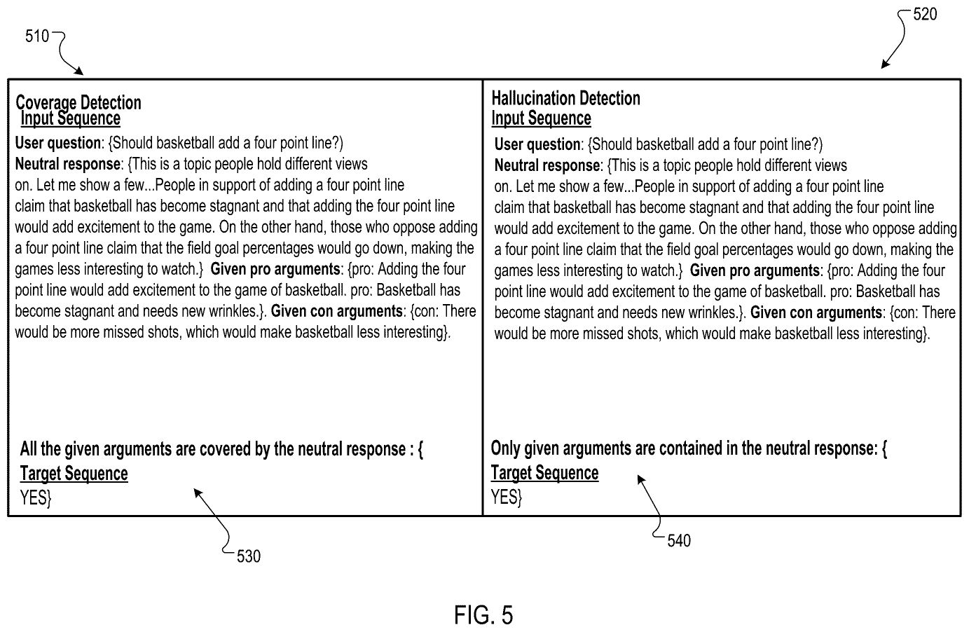

FIG. 5 shows examples 510 and 520 of inputs that can be processed by the language model neural network to detect errors.

In particular, FIG. 5 shows an example input sequence 510 that can be processed by the language model neural network to detect coverage errors. As can be seen from FIG. 5, the example input sequence 510 includes a user query (“should basketball add a four point line?”) and a neutral response generated by the chat bot after being given “pro” arguments that support adding the four point line and “con” arguments that are against adding the four point line.

The input sequence 510 also includes a query for the coverage detection task (“all the given arguments are covered by the neutral response”). Moreover, while not shown in FIG. 5, the input sequence 510 can also include a “soft” prompt for the coverage detection task that has been learned through prompt tuning as described above.

FIG. 5 also shows an example target sequence 530 that should be generated by the language model neural network by processing the example input sequence 510. That is, FIG. 5 shows that the language model neural network should generate “YES” because the neutral response “covers” all of the pro and con arguments.

FIG. 5 also shows an example input sequence 520 that can be processed by the language model neural network to detect hallucination errors. As can be seen from FIG. 5, the example input sequence 520 includes the same user query, neutral response, and pro and con arguments as the input sequence 510, but includes a query for the hallucination detection task (“only given arguments are contained in the neutral response”).

Moreover, while not shown in FIG. 5, the input sequence 520 can also include a “soft” prompt for the hallucination detection task that has been learned through prompt tuning as described above.

FIG. 5 also shows an example target sequence 540 that should be generated by the language model neural network by processing the example input sequence 520. That is, FIG. 5 shows that the language model neural network should generate “YES” because the neutral response does not summarize any arguments that are not contained in the pro and con arguments.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving an input query and a plurality of candidate responses to the input query;
receiving a response generated by chat bot software for the input query that summarizes the candidate responses to the input query; and
processing a language model input that comprises (i) the input query, (ii) the plurality of candidate responses, and (ii) the response generated by the chat bot software using a language model neural network to generate a classification output that characterizes whether the response generated by the chat bot has an error of a first error type.

2. The method of claim 1, further comprising:
classifying the response as either containing an error of the first error type or not containing an error of the first error type based on the classification output.

3. The method of claim 1, further comprising:
determining whether to deploy the chat bot software for responding to user queries based at least in part on the classification output.

4. The method of claim 1, wherein the classification output is a confidence score that represents a likelihood that the response has an error of the first error type.

5. The method of claim 4, wherein processing an input that comprises (i) the input query, (ii) the plurality of candidate responses, and (ii) the response generated by the chat bot software using a language model neural network to generate a classification output that characterizes whether the response generated by the chat bot has an error comprises:
processing an input that comprises (i) the input query, (ii) the plurality of candidate responses, and (ii) the response generated by the chat bot software using the language model neural network to generate a first score for a first natural language label that indicates that the response contains an error of the first error type and a second score for a second natural language label that indicates that the response does not contain an error of the first error type; and
generating the confidence score from at least the first score and the second score.

6. The method of claim 5, wherein the confidence score is a probability and wherein generating the confidence score comprises applying a softmax function to a set of scores that includes the first score and the second score.

7. The method of claim 1, wherein the first error type is a hallucination error that occurs when the response generated by the chat bot software references a candidate response that was not included in the plurality of candidate responses.

8. The method of claim 1, wherein the first error type is a coverage error that occurs when the response generated by the chat bot software does not reference one or more of the candidate responses that were included in the plurality of candidate responses.

9. The method of claim 1, wherein the language model input further comprises a first prompt corresponding to the first error type.

10. The method of claim 9, further comprising:
processing a second language model input that comprises (i) the input query, (ii) the plurality of candidate responses, (iii) the response generated by the chat bot software, and (iv) a second prompt corresponding to a second, different error type using a language model neural network to generate a second classification output that characterizes whether the response generated by the chat bot has an error of the second error type.

11. The method of claim 9, wherein the first prompt is a prompt that has been learned through prompt tuning on a training data set that includes a plurality of first training examples, each first training example comprising: (i) a training query, (ii) a plurality of candidate responses to the training query, (iii) a training response to the training query, and (iv) a ground truth label indicating whether the training response contains an error of the first type.

12. The method of claim 10, wherein the second prompt is a prompt that has been learned through prompt tuning on a training data set that includes a plurality of second training examples, each second training example comprising: (i) a training query, (ii) a plurality of candidate responses to the training query, (iii) a training response to the training query, and (iv) a ground truth label indicating whether the training response contains an error of the second type.

13. The method of claim 1, wherein the chat bot software provides responses generated by one or more large language models (LLMs) in response to user queries.

14. The method of claim 1, wherein the language model input further comprises (v) text referencing the first error type.

15. One or more non-transitory computer storage media storing instructions that when executed by one or more computers cause the one more computers to perform operations comprising:
receiving an input query and a plurality of candidate responses to the input query;
receiving a response generated by chat bot software for the input query that summarizes the candidate responses to the input query; and
processing a language model input that comprises (i) the input query, (ii) the plurality of candidate responses, and (ii) the response generated by the chat bot software using a language model neural network to generate a classification output that characterizes whether the response generated by the chat bot has an error of a first error type.

16. A system comprising one or more computers and one or more storage devices storing instructions that when executed by one or more computers cause the one more computers to perform operations comprising:
receiving an input query and a plurality of candidate responses to the input query;
receiving a response generated by chat bot software for the input query that summarizes the candidate responses to the input query; and
processing a language model input that comprises (i) the input query, (ii) the plurality of candidate responses, and (ii) the response generated by the chat bot software using a language model neural network to generate a classification output that characterizes whether the response generated by the chat bot has an error of a first error type.

17. The system of claim 16, the operations further comprising:
classifying the response as either containing an error of the first error type or not containing an error of the first error type based on the classification output.

18. The system of claim 16, the operations further comprising:
determining whether to deploy the chat bot software for responding to user queries based at least in part on the classification output.

19. The system of claim 16, wherein the classification output is a confidence score that represents a likelihood that the response has an error of the first error type.

20. The system of claim 19, wherein processing an input that comprises (i) the input query, (ii) the plurality of candidate responses, and (ii) the response generated by the chat bot software using a language model neural network to generate a classification output that characterizes whether the response generated by the chat bot has an error comprises:
processing an input that comprises (i) the input query, (ii) the plurality of candidate responses, and (ii) the response generated by the chat bot software using the language model neural network to generate a first score for a first natural language label that indicates that the response contains an error of the first error type and a second score for a second natural language label that indicates that the response does not contain an error of the first error type; and
generating the confidence score from at least the first score and the second score.
